(19) United States
(12) Patent Application Publication
(10) Pub. No.: US 2011/0266321 A1
(43) Pub. Date: Nov. 3, 2011

(54) Holding device for bicycles accessories

(76) Inventor: Wei-Chun Hsueh, Taichung (TW)

(21) Appl. No.: 12/926,300

(22) Filed: Nov. 9, 2010

(30) Foreign Application Priority Data
Apr. 28, 2010 (TW) 099207794

(51) Int. Cl. B62J 11/00

(52) U.S. Cl. 224/448

(57) ABSTRACT

A holding device for bicycles accessories contains a base including a locking structure disposed on one end thereof to hold a bicycle accessory, a clamping structure arranged on another end thereof to clamp a frame or a handle of the bicycle, and a support mounted on a bottom end thereof.

### BACKGROUND OF THE INVENTION

1. Field of the Invention

The present invention relates to a holding device for bicycles accessories that allows to fix the base and hold an accessory hanged on the base securely.

2. Description of the Prior

Referring to FIG. 1, a conventional holding device for bicycles accessories includes a base 10, the base 10 includes a retaining portion 11 disposed on one end thereof to retain and hang an accessory 20, an upper clamping piece 12 and a lower clamping piece 13 mounted on another end thereof, one ends of the upper and the lower clamping pieces 12, 13 are connected with each other axially so that the upper and the lower clamping pieces 12, 13 are axially expended and retracted, the upper and the lower clamping pieces 12, 13 include a first and a second arcuate grooves 121, 131 fixed thereon respectively to be opposite to each other, and the first and the second arcuate grooves 121, 131 include anti-slip pads 14 installed therein individually, the first and the second clamping pieces 12, 13 include bolt elements 15 attached on another ends thereof respectively to clamp and screw the upper and the lower clamping pieces 12, 13 onto two handles 21 of the bicycle by using the bolt elements 15, such that the retaining portion 11 of the base 10 is used to hang the accessory 20 during riding. However, the base 10 still has the following disadvantages:

1. As the retaining portion 11 of the base 10 is used to retain and hang the accessory 20, the anti-slip pads 14 of the upper and the lower clamping pieces 12, 13 can not prevent the base 10 and the accessory 20 from vibration effectively, therefore if the accessory 20 is heavy, the upper and the lower clamping pieces 12, 13 of the base 10 fall downward along the handles 21 that can not hang the accessory 20 securely.

2. Because the upper and the lower clamping pieces 12, 13 of the base 10 can not hang the accessory 20 securely, causing vibration and damage during riding.

3. The base 10 falls downward due to weight of the accessory 20, accordingly the anti-slip pads 14 are worn and become deformed to decrease service life of the base 10.

The present invention has arisen to mitigate and/or obviate the afore-described disadvantages.

### SUMMARY OF THE INVENTION

The primary object of the present invention is to provide a holding device for bicycles accessories that can support the base to hang an accessory securely.

A holding device for bicycles accessories according to the present invention comprises a base including a locking structure disposed on one end thereof to hold a bicycle accessory; a clamping structure arranged on another end thereof to clamp a frame or a handle of the bicycle; and a support mounted on a bottom end thereof; wherein the locking structure includes a plate member mounted on the one end of the base, a groove fixed besides the plate member, a retaining block and a button, both of which are received in the groove, one end of the retaining block extends out of the plate member to position the bicycle accessory, and the button is pressed to retract the retaining block so as to release the bicycle accessory from the holding device; wherein the clamping structure includes a first clamping portion secured to two sides of the another end of the base, and the first clamping portion includes a second clamping portion attached below the first clamping portion to be clamped to two handles of a front end of a frame.

### BRIEF DESCRIPTION OF THE DRAWINGS

FIG. 1 is a side plan view of a conventional holding device for bicycles accessories;

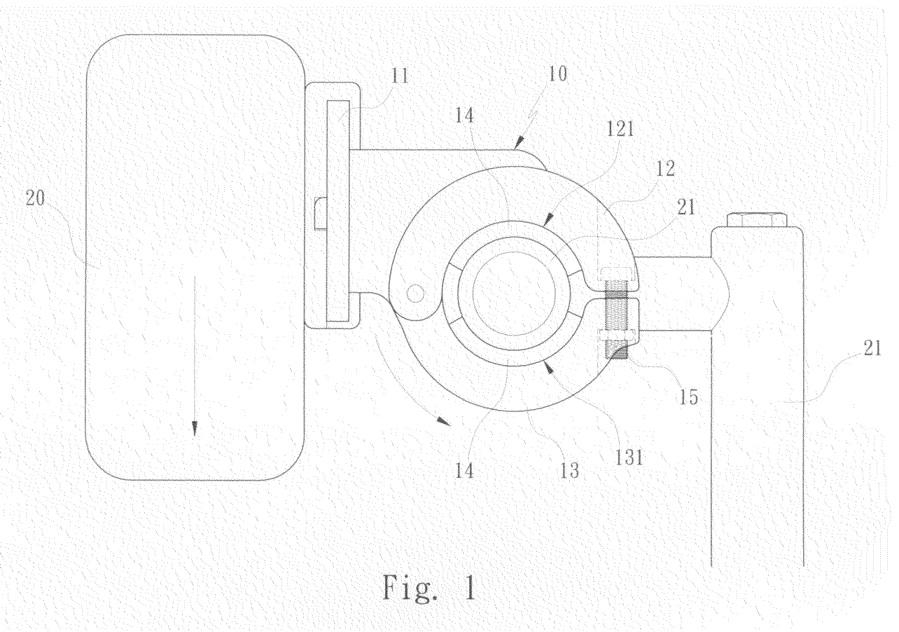

FIG. 2 is a perspective view showing the exploded components of a holding device for bicycles accessories according to a preferred embodiment of the present invention;

FIG. 3 is a perspective view showing the assembly of the holding device for bicycles accessories according to the preferred embodiment of the present invention;

FIG. 4 is a cross sectional view showing the assembly of the holding device for bicycles accessories according to the preferred embodiment of the present invention;

FIG. 5 is a cross sectional view showing the operation of the holding device for bicycles accessories according to the preferred embodiment of the present invention;

FIG. 6 is another cross sectional view showing the operation of the holding device for bicycles accessories according to the preferred embodiment of the present invention;

FIG. 7 is another cross sectional view showing the operation of the holding device for bicycles accessories according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

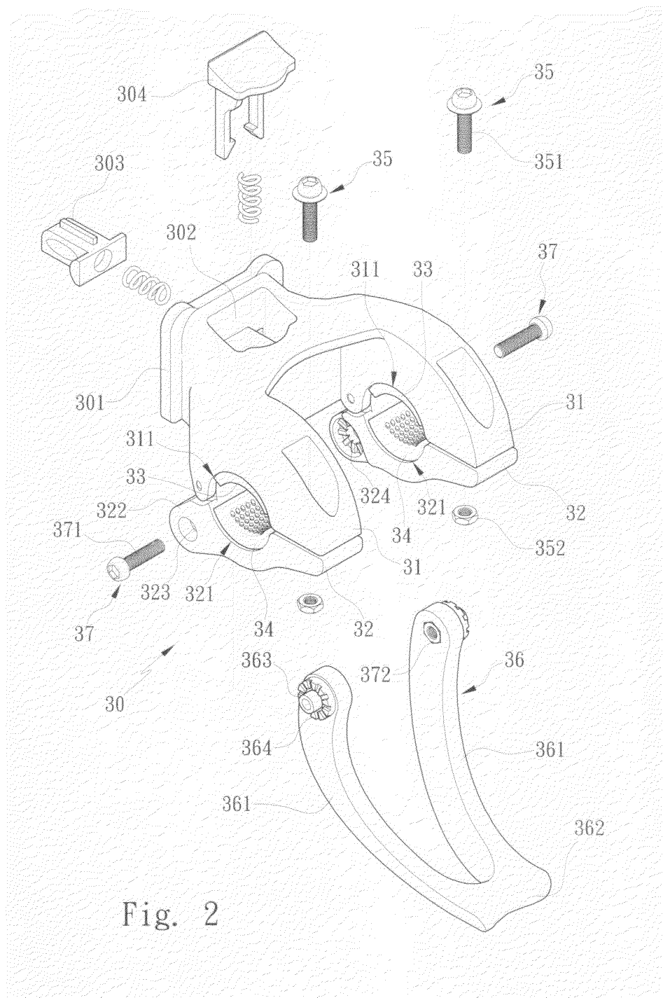

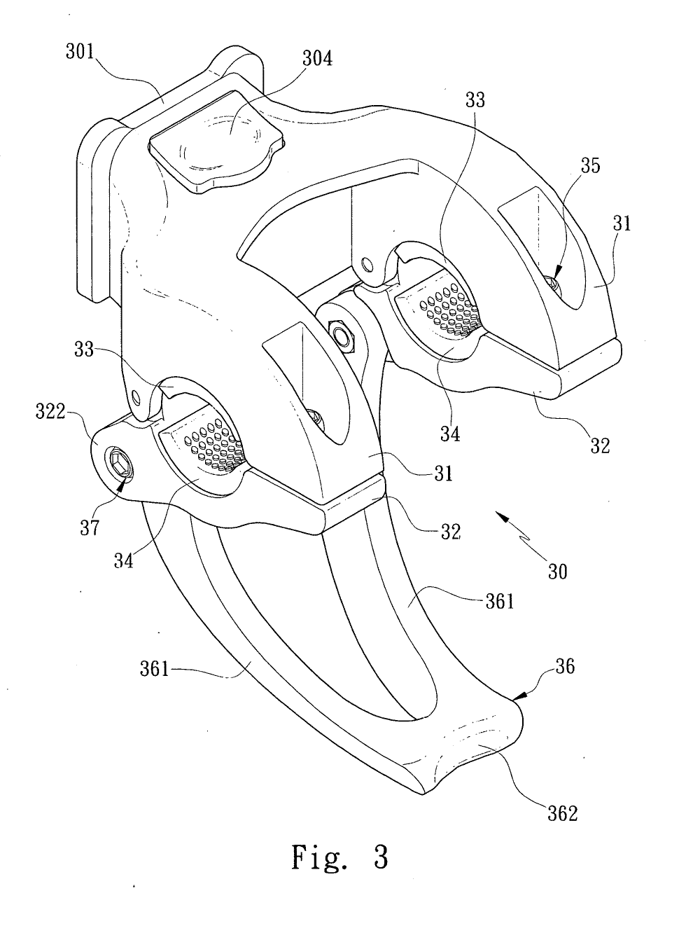

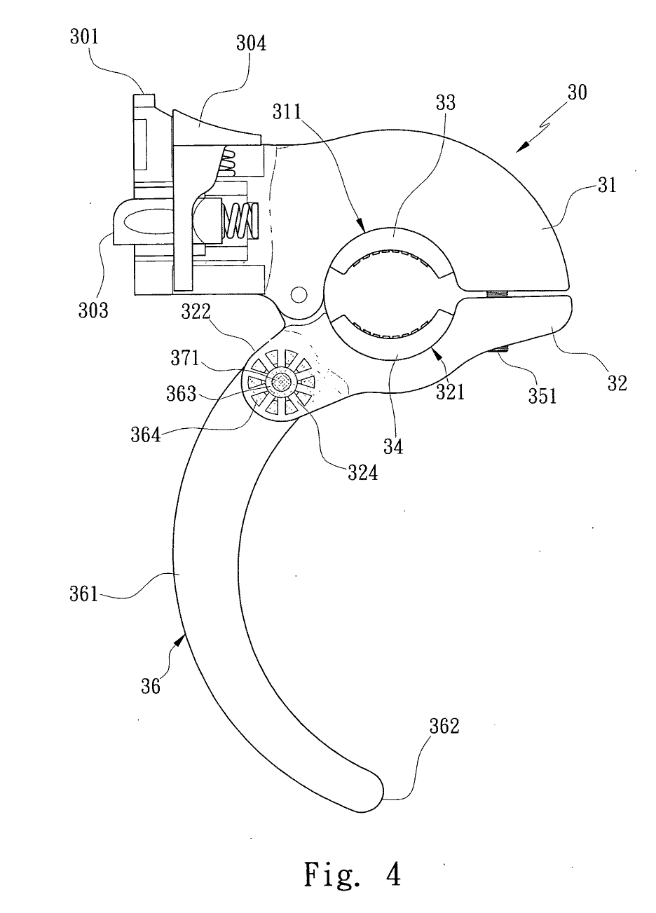

Referring to FIGS. 2-4, a holding device for bicycles accessories according to the present invention comprises a base 30 including a locking structure disposed on one end thereof to hold a bicycle accessory, the locking structure includes a plate member 301 mounted on the one end of the base 30, a groove 302 fixed besides the plate member 301, a retaining block 303 and a button 304, both of which are received in the groove 302, wherein one end of the retaining block 303 extends out of the plate member 301 to position the bicycle accessory, and the button 304 is pressed to retract the retaining block 303 so as to release the bicycle accessory from the holding device. The base 30 also includes a clamping structure arranged on another end thereof to clamp a frame or a handle of the bicycle. The clamping structure includes a first clamping portion 31 secured to two sides of the another end of the base 30, and the first clamping portion 31 includes a second clamping portion 32 attached below the first clamping portion 31, and one end of the second clamping portion 32 is axially connected with one end of the first clamping portion 31 so that the first and the second clamping portions 31, 32 are axially rotated to expand and retract. The first clamping portion 31 includes a first arcuate slot 311 disposed thereon, and the first arcuate slot 311 includes a first anti-slip pad 33 mounted therein, the second clamping portion 32 includes a second arcuate slot 321 fixed thereon to correspond to the first arcuate slot 311 of the first clamping portion 31, and the second arcuate slot 321 includes a second anti-slip pad 34 arranged therein, the first and the second clamping portions 31, 32 include first bolt elements 35 with first bolts 351 and first nuts 352 disposed on another ends thereof respectively to screw the first and the second clamping portions 31, 32. The base 30 includes a support 36 mounted on a bottom end thereof, and the support 36 includes two arcuate rods 361 opposite to each other, one ends of the rods 361 are axially fixed to two sides of the second clamping portion 32, and another ends thereof are connected with each other, and between a connection of the another ends of the rods 361 is defined an abutting portion 362, between the rods 361 of the support 36 and the base 30 is defined a positioning structure to adjust the support 36 to be rotably fixed to a suitable angle, and the abutting portion 362 of the support 36 is biased against the bike head tube below the base 30. The one ends of the rods 361 of the supports 36 are axially fixed to the second clamping portion 32 of the base 30, and the second clamping portion 32 includes an axial coupling segment 322 with a hole 323 disposed on the one end thereof, the rod 361 of the support 36 includes a rotary shaft 363 mounted on the one end thereof to be inserted to the hole 323 of the second clamping portion 32, and the positioning structure includes an inner toothed disc 324 disposed on one end of the hole 323 of the second clamping portion 32, the rotary shaft 363 of the support 36 includes an outer toothed disc 364 mounted around a periphery thereof to mesh with the inner toothed disc 324 of the second clamping portion 32, and two second bolt elements 37 with two second bolts 371 and two second nuts 372 individually are fitted to the holes 323 of the second clamping portion 32 and the rotary shafts 363 of the support 36 so that the axial coupling segment 322 of the second clamping portion 32 is screwed with the rod 361 of the support 36, and the inner toothed disc 324 of the second clamping portion 32 meshes with the outer toothed disc 364 of the support 36 to rotate the support 36 axially.

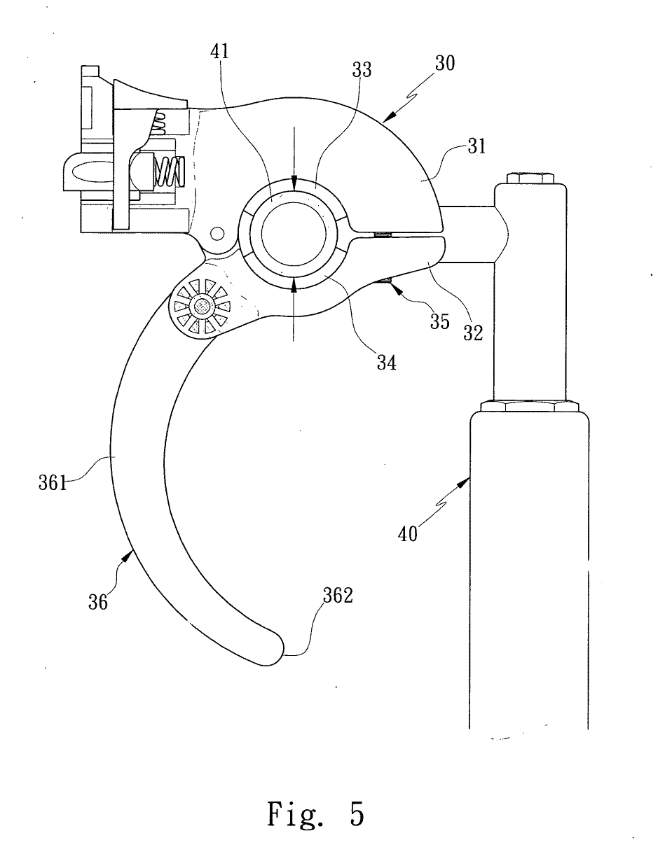

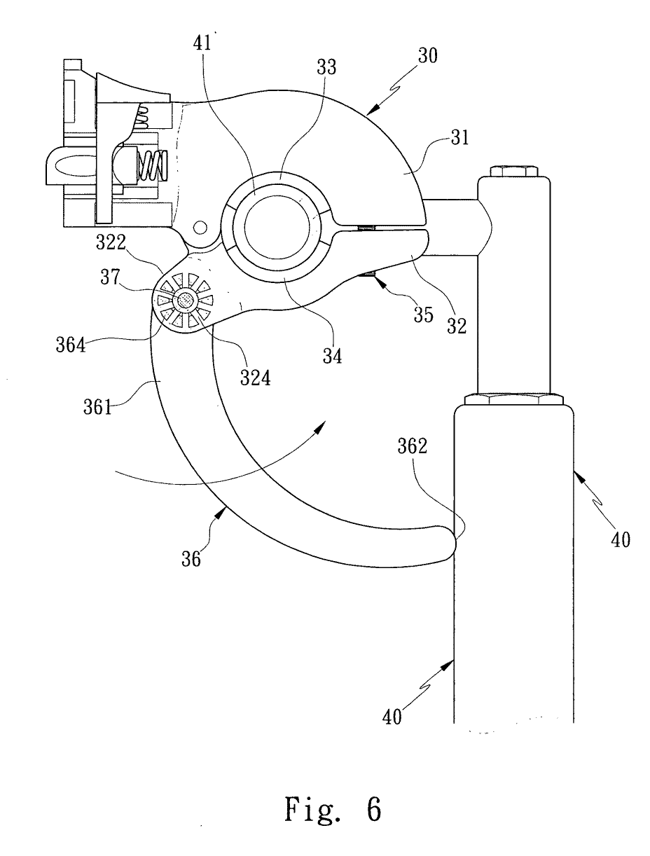

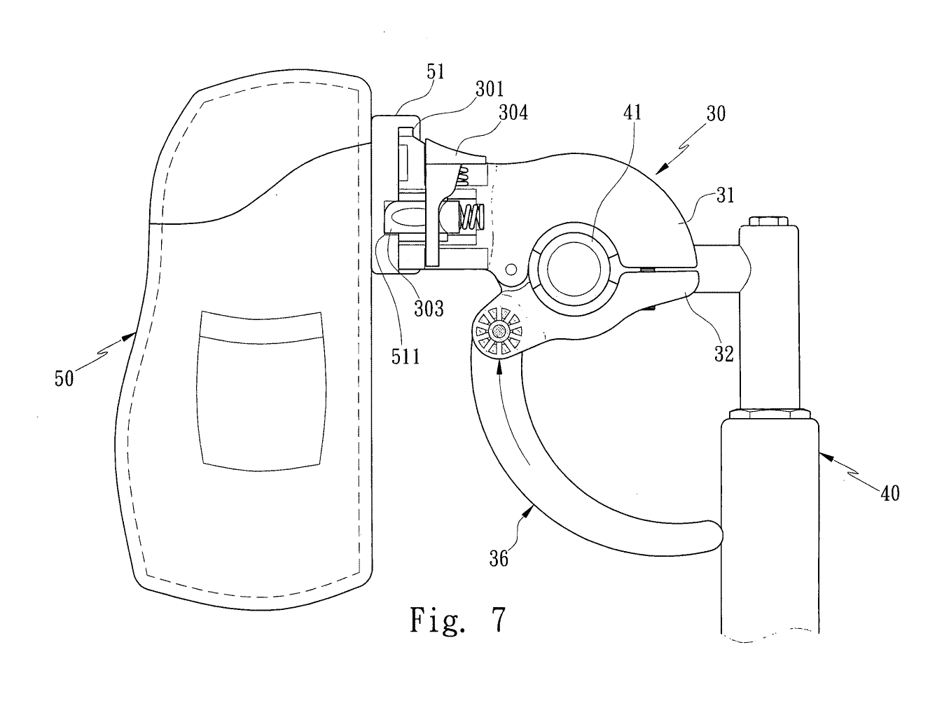

As shown in FIG. 5, in operation, the first and the second clamping portions 31, 32 of the base 30 are clamped to two handles 41 of a front end of a frame 40 and then to be screwed together by using the first bolt elements 35 so that the first and the second anti-slip pads 33, 34 are forced to the handles 41. hence the base 30 is fixed to the handles 41. As illustrated in FIG. 6, the support 36 is rotated to the suitable angle, and the abutting portion 362 of the support 36 abuts against the frame 40 below the base 30 to be fixed by using the second bolt element 37, hence the inner toothed disc 324 of the second clamping portion 32 engages with the outer toothed disc 364 of the support 36, thus fixing the support 36 onto the suitable angle to position the base 30 to the handle 41. Referring to FIG. 7, during riding bicycle, an accessory 50 of a fitting portion 51 is hanged to the plate member 301 of the base 30, and the fitting portion 51 of the accessory 50 includes a positioning recess 511 secured thereon to receive the retaining block 303 so as to position the accessory 50. Thereafter, the support 36 is used to support the base 30 and the accessory 50 securely, obtaining riding safety and long service life.

While we have shown and described various embodiments in accordance with the present invention, it is clear to those skilled in the art that further embodiments may be made without departing from the scope of the present invention.

What is claimed is:

1. A holding device for bicycles accessories comprising:
a base including a locking structure disposed on one end thereof to hold a bicycle accessory;
a clamping structure arranged on another end thereof to clamp a frame or a handle of the bicycle; and
a support mounted on a bottom end thereof.

2. The holding device for the bicycles accessories as claimed in claim 1, wherein the locking structure includes a plate member mounted on the one end of the base, a groove fixed besides the plate member, a retaining block and a button, both of which are received in the groove, one end of the retaining block extends out of the plate member to position the bicycle accessory, and the button is pressed to retract the retaining block so as to release the bicycle accessory from the holding device.

3. The holding device for the bicycles accessories as claimed in claim 1, wherein the clamping structure includes a first clamping portion secured to two sides of the another end of the base, and the first clamping portion includes a second clamping portion attached below the first clamping portion to be clamped to two handles of a front end of a frame.

4. The holding device for the bicycles accessories as claimed in claim 3, wherein one end of the second clamping portion is axially connected with one end of the first clamping portion, the first clamping portion includes a first arcuate slot disposed thereon, and the second clamping portion includes a second arcuate slot fixed thereon to correspond to the first arcuate slot of the first clamping portion, the first and the second clamping portions include first bolt elements disposed on another ends thereof respectively to screw the first and the second clamping portions.

5. The holding device for the bicycles accessories as claimed in claim 4, wherein the first bolt element includes a first bolt and a first nut.

6. The holding device for the bicycles accessories as claimed in claim 4, wherein the first arcuate slot includes a first anti-slip pad mounted therein, and the second arcuate slot includes a second anti-slip pad arranged therein.

7. The holding device for the bicycles accessories as claimed in claim 3, wherein the support includes two arcuate rods opposite to each other, one ends of the rods are axially fixed to two sides of the base and another ends thereof are connected with each other, and between a connection of the another ends of the rods is defined an abutting portion to abut against the frame below the base, between the rods of the support and the base is defined a positioning structure to adjust the support to be rotably fixed to a suitable angle.

8. The holding device for the bicycles accessories as claimed in claim 7, herein the second clamping portion includes an axial coupling segment with a hole disposed on the one end thereof, the rod of the support includes a rotary shaft mounted on the one end thereof to be inserted to the hole of the second clamping portion.

9. The holding device for the bicycles accessories as claimed in claim 8, wherein the positioning structure includes an inner toothed disc disposed on one end of the hole of the second clamping portion, the rotary shaft of the support includes an outer toothed disc mounted around a periphery thereof to mesh with the inner toothed disc of the second clamping portion, and two second bolt elements are fitted to the holes of the second clamping portion and the rotary shafts of the support so that the axial coupling segment of the second clamping portion is screwed with the rod of the support, and the inner toothed disc of the second clamping portion meshes with the outer toothed disc of the support to rotate the support axially.

10. The holding device for the bicycles accessories as claimed in claim 9, wherein the second bolt element includes a second bolt and a second nut.
